(19) United States
(12) Patent Application Publication
(10) Pub. No.: US 2010/0164845 A1
(43) Pub. Date: Jul. 1, 2010

(54) MODULATION APPARATUS AND IMAGE DISPLAY APPARATUS

(75) Inventors: Ayako Takagi, Kanagawa-Ken (JP); Masahiro Baba, Kanagawa-Ken (JP); Haruhiko Okumura, Kanagawa-Ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA, Minato-ku, Tokyo (JP)

(21) Appl. No.: 12/160,828

(22) PCT Filed: May 19, 2008
(86) PCT No.: PCT/JP2008/059597

§ 371 Date: Jul. 14, 2008

(30) Foreign Application Priority Data
May 21, 2007 (JP) 2007-134122

(51) Int. Cl. G09G 3/20; H04B 3/00

(52) U.S. Cl. 345/58; 375/295; 375/257

(57) ABSTRACT

A differential data array group, which have at least a plurality of pairs of a differential data to transmit a serial signal, includes difference absolute value data having a plurality of bits to represent an absolute value obtained by converting gray scale level data of red, green and blue to binary number data, and sign data having at least one bit to represent a sign of the gray scale level data. With respect to one pair of the differential data, gray scale level data corresponding to one pixel are arranged in an ascending order or a descending order. With respect to another pair of the differential data, the sign data corresponding to one pixel are arranged into a former half or a latter half of a time period corresponding to one pixel. Data of a highest order bit of the difference absolute value data corresponding to one pixel are arranged into the latter half or the former half of the time period corresponding to one pixel.

### BACKGROUND OF THE INVENTION

1. Field of the Invention

The present invention relates to an image display apparatus, and in particular to a modulation apparatus and an image display apparatus subjected to a countermeasure for reducing unwanted emission noise.

2. Related Art

An image display apparatus such as a liquid crystal display (LCD), LED display, a plasma display panel (PDP), an field emission display (FED) or an electroluminescent (EL) display includes pixels arranged in a matrix form, a signal line drive circuit to supply an image signal to the pixels, and a circuit substrate to transmit image data to the signal line drive circuit. Image data converted into a digital signal is transmitted on the circuit substrate and input to the signal line drive circuit.

In general, digital image data input to the signal line drive circuit are data supplied to pixels corresponding to color elements such as red (R), green (G) and blue (B). These data are transmitted in parallel. In other words, if the gray scale level of each color element is represented by 8 bits, digital image data of 8 bits×3=24 bits is transmitted.

In recent years, image display devices have been made large in screen and high in definition. As a result, the frequency of image data transmitted over a transmission line on the circuit board of the image display devices has also become very high. When digital data having a high frequency is transmitted, electromagnetic noise called electromagnetic interference (EMI) is caused in some cases. Thus, the necessity of reducing the EMI is increasing.

As the method for reducing the EMI, differential data transmission systems such as, for example, LVDS (Low Voltage Differential Signaling), TMDS (Transition Minimized Differential Signaling), and RSDS (Reduced Swing Differential Signaling), are proposed.

In recent years, however, image display devices such as liquid crystal displays have been made high in definition. Even if conversion to a small amplitude differential signal is conducted as in the LVDS, the EMI generated from the transmission line is posing a problem. As one of methods for solving this problem, there is the “vertical differential transmission system” which is a transmission system for reducing the EMI with a circuit configuration of a comparatively small scale (Japanese Patent No. 3645514 and Japanese Patent No. 3840176).

In recent years, the number of gray scale levels in image signals is increasing more and more as in 2⁶=64 gray scale levels, 2⁸=256 gray scale levels, and 2¹⁰=1024 gray scale levels. The data transmission system for transmitting differential signals includes not only LVDS data, but also TMDS, RSDS and Display Port widely. In a conventional system, transmission is conducted over a plurality of differential wires by arranging data bit information over a plurality of serial data wires in one clock period. However, an arrangement method which is optimum when conducting vertical difference processing on image data having an arbitrary transmission array and an arbitrary gray scale level and conducting data bit mapping is not known.

### SUMMARY OF THE INVENTION

The present invention has been made in view of these circumstances, and an object of thereof is to provide a modulation apparatus, a demodulation apparatus, and an image display apparatus capable of reducing EMI generated from a differential transmission line regardless of the number of bits and the number of serial data when transmitting image data as a serial differential signal.

A modulation apparatus according to an aspect of the present invention includes: a differential encoding unit configured to encode digital image data to vertical differential digital data; and a differential signal transmitter configured to transmit a serial signal based on the vertical differential digital data, wherein a differential data array group, which have at least a plurality of pairs of a differential data to transmit the serial signal, comprises difference absolute value data having a plurality of bits to represent an absolute value obtained by converting gray scale level data of red, green and blue to binary number data, and sign data having at least one bit to be based on the vertical differential digital data of red, green and blue, and the differential signal transmitter unit, with respect to one pair of the differential data, arranges the plurality of bits corresponding to one pixel to a serial signal in an ascending order or a descending order, and with respect to another adjacent pair of the differential data, arranges the sign data corresponding to one pixel into a former half or a latter half of a time period for arranging the serial signal corresponding to one pixel, and arranges data of a highest order bit of the difference absolute value data corresponding to one pixel into the latter half or the former half of the time period for arranging the serial signal corresponding to one pixel.

A modulation apparatus according to another aspect of the present invention includes: a differential encoding unit configured to encode digital image data to vertical differential digital data; and a differential signal transmitter unit configured to transmit a serial signal based on the vertical differential digital data, wherein a differential data array group, which have at least a plurality of pairs of a differential data to transmit the serial signal, comprises difference absolute value data having a plurality of bits to represent an absolute value obtained by converting gray scale level data of red, green and blue to binary number data, sign data having at least one bit to be based on the vertical differential digital data of red, green and blue, and control data having at least one bit, and the differential signal transmitter unit, with respect to one pair of the differential data, arranges the plurality of bits corresponding to one pixel to a serial signal in an ascending order or a descending order, and with respect to another adjacent pair of the differential data, arranges the sign data corresponding to one pixel into a former half or a latter half of a time period for arranging the serial signal corresponding to one pixel, and arranges the control data corresponding to one pixel into the latter half or the former half of the time period for arranging to the serial signal corresponding to one pixel.

An image display apparatus according to an additional aspect of the present invention includes: a differential encoding unit configured to encode digital image data to vertical differential digital data; a differential signal transmitter configured to transmit a serial signal based on the vertical differential digital data; at least one pair of differential signal transmission lines used to transmit the serial signal; a differential signal receiver configured to receive the serial signal transmitted via the differential signal transmission lines and output vertical differential digital data; a vertical differential decoding unit configured to decode the vertical differential digital data to digital image data; and an image display unit configured to be supplied with the digital image data as an input and display an image based on the digital image data, wherein a differential data array group, which have at least a plurality of pairs of a differential data to transmit the serial signal, comprises difference absolute value data having a plurality of bits to represent an absolute value obtained by converting gray scale level data of red, green and blue to binary number data, and sign data having at least one bit to be based on the vertical differential digital data of red, green and blue, and the differential signal receiver, with respect to one pair of the differential data, arranges the gray scale level data corresponding to one pixel to a serial signal in an ascending order or a descending order, and with respect to another pair of the differential data, arranges the sign data corresponding to one pixel into a former half or a latter half of a time period for arranging the serial signal corresponding to one pixel, and arranges data of a highest order bit of the difference absolute value data corresponding to one pixel into the latter half or the former half of the time period for arranging the serial signal corresponding to one pixel.

An image display apparatus according to another additional aspect of the present invention includes: a differential encoding unit configured to encode digital image data to vertical differential digital data; a differential signal transmitter configured to transmit a serial signal based on the differential digital data; at least one pair of differential signal transmission lines used to transmit the serial signal; a differential signal receiver configured to receive the serial signal transmitted via the differential signal transmission line and output vertical differential digital data; a vertical differential decoding unit configured to decode the vertical differential digital data to digital image data; and an image display unit configured to be supplied with the digital image data as an input and display an image based on the digital image data, wherein a differential data array group, which have at least a plurality of pairs of a differential data to transmit the serial signal, comprises difference absolute value data having a plurality of bits to represent an absolute value obtained by converting gray scale level data of red, green and blue to binary number data, sign data having at least one bit to be based on the vertical differential digital data of red, green and blue, and control data having at least one bit, and the differential signal receiver, with respect to one pair of the differential data, modulates the gray scale level data corresponding to one pixel to a serial signal in an ascending order or a descending order, and with respect to another pair of the differential data, arranges the sign data corresponding to one pixel into a former half or a latter half of a time period for arranging the serial signal corresponding to one pixel, and arranges the control data corresponding to one pixel into the latter half or the former half of the time period for arranging the serial signal corresponding to one pixel.

### BRIEF DESCRIPTION OF THE DRAWINGS

FIG. 1 is a block diagram showing a principal part of an image display apparatus according to an embodiment;

FIG. 2 is a block diagram showing an example of a configuration of a vertical differential encoding unit;

FIG. 3 is a block diagram showing an example of a configuration of a vertical differential decoding unit;

FIG. 4 is a concept diagram for explaining a serial transmission array group according to an embodiment;

FIGS. 5A and 5B are schematic diagrams showing states of an electromagnetic field generated on a differential signal line when unevenness has occurred in a differential signal;

FIG. 6 is a schematic diagram showing current flows generated when potentials on respective differential transmission lines have changed in two sets of differential transmission lines;

FIG. 7 is a schematic diagram showing electromagnetic fields generated from two differential transmission lines;

FIG. 8 is a schematic diagram showing that current quantities flowing through a transmission line 1-1 and a transmission line 2-2 become greater than current quantities flowing through a transmission line 1-2 and a transmission line 2-1 when a signal on a differential transmission line 1 changes from L to H and a signal on a differential transmission line 2 changes from L to H;

FIG. 9 is a schematic diagram showing that electromagnetic fields generated from two differential transmission lines cancel each other because directions of electromagnetic fields generated from respective transmission lines become opposite in phase and EMI is reduced;

FIG. 10 is a histogram of a natural image A according to the gray scale level;

FIG. 11 is a histogram of a character image according to the gray scale level;

FIG. 12 shows a probability of assuming 0 every data bit after vertical difference processing on a natural image A;

FIG. 13 shows a probability of assuming 0 every data bit after vertical difference processing on a natural image B;

FIG. 14 shows a probability of assuming 0 every data bit after vertical difference processing on a natural image C;

FIG. 15 shows a probability of assuming 0 every data bit after vertical difference processing on a character image;

FIG. 16 shows a probability of assuming 0 every data bit after vertical difference processing on a working screen;

FIG. 17 is a diagram for explaining luminance of a vertical difference image according to the color;

FIG. 18 shows a radiant intensity of a vertical component according to the 3M method from a liquid crystal monitor when a character image original picture and a natural image original picture are displayed;

FIGS. 19(a-1) to 19(c-2) are diagrams for explaining a procedure in an embodiment of the present invention;

FIGS. 20A and 20B are schematic diagrams showing data mapping of arranging 7-bit vertical difference image data in 7-column serial data when N=0 and data waveforms according to the gray scale level;

FIG. 21 is a schematic diagram of data mapping of arranging 7-bit vertical difference image data in 7-column serial data over two clock periods when N=0;

FIG. 22 shows a radiant intensity of a vertical component according to the 3M method from a liquid crystal monitor when a character image original picture, a vertical difference image, and an image subjected to optimum data mapping are displayed;

FIG. 23 is a schematic diagram showing a probability of assuming 0 every data bit after vertical difference processing on an 8-bit original picture and a 7-bit original picture in a natural image B;

FIG. 24 is a schematic diagram of data mapping of arranging 5-bit vertical difference image data in 7-column serial data when N<0;

FIG. 25 is a schematic diagram of data mapping of arranging 6-bit vertical difference image data in 7-column serial data when N<0;

FIG. 26 show an example of data mapping of arranging 6-bit vertical difference image data in 7-column serial data over two clock periods when N<0;

FIG. 27 is a schematic diagram of data mapping of arranging 9-bit vertical difference image data in 7-column serial data when N<0;

FIG. 28 is a schematic diagram of data mapping of arranging 9-bit vertical difference image data in 7-column serial data when N>0;

FIG. 29 is a schematic diagram of data mapping of arranging 10-bit vertical difference image data in 7-column serial data when N>0;

FIG. 30 is a schematic diagram of data mapping of arranging 9-bit vertical difference image data in 7-column serial data over two clock periods when N>0;

FIG. 31 is a schematic diagram of data mapping of arranging 10-bit vertical difference image data in 7-column serial data over two clock periods when N>0;

FIG. 32 is a schematic diagram of data mapping of arranging 7-bit vertical difference image data in 2-column serial data when N>0;

FIG. 33 is a schematic diagram of data mapping of arranging 8-bit vertical difference image data in 2-column serial data when N>0; and

FIG. 34 is a schematic diagram of data mapping of arranging 9-bit vertical difference image data in 2-column serial data when N>0.

### DESCRIPTION OF THE EMBODIMENTS

Hereafter, embodiments of the present invention will be described in detail with reference to the drawings.

### First Embodiment

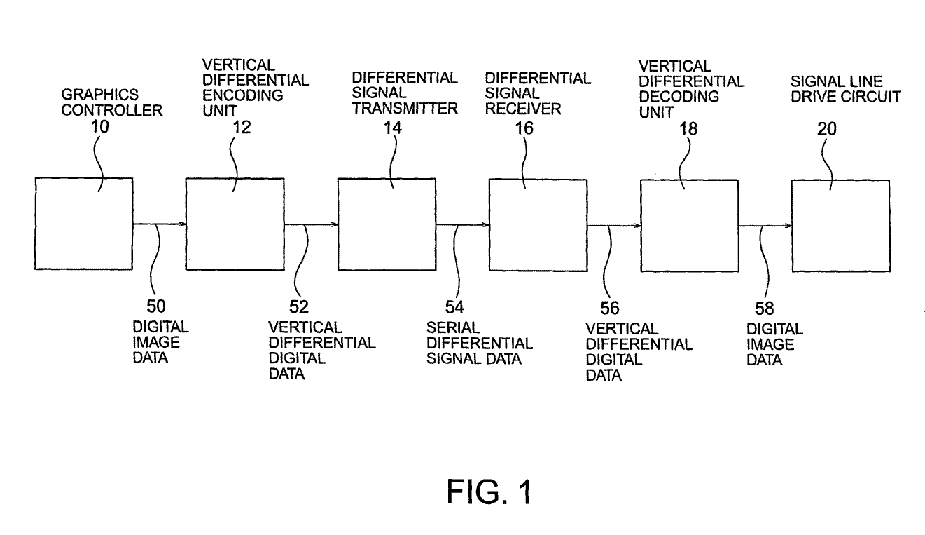

FIG. 1 is a block diagram showing a principal part of an image display apparatus according to an embodiment of the present invention. In other words, FIG. 1 shows a specific example of the case where the present invention is applied to a liquid crystal display device.

Digital image data 50 which is output from a graphics controller 10 is encoded to vertical differential digital data 52 by a vertical differential encoding unit 12. The vertical differential digital data 52 obtained by the encoding is converted to a serial differential signal data 54 by a differential signal transmitter 14. The serial differential signal data 54 obtained by the conversion to the serial differential signal by the differential signal transmitter 14 is input to a differential signal receiver 16 via, for example, four pairs of differential signal transmission lines. At this time, a clock signal is also transmitted to the differential signal receiver 16 by a pair of differential signal transmission line provided separately.

The differential signal receiver 16 receives the serial differential signal data 54 and outputs vertical differential digital data 56 to a vertical differential decoding unit 18. The vertical differential decoding unit 18 decodes the vertical differential digital data 56 to digital image data 58. The digital image data 58 obtained by the decoding is input to a signal line drive circuit 20 in a liquid crystal display unit and an image is displayed on the liquid crystal display unit.

Operations of the respective units will now be described.

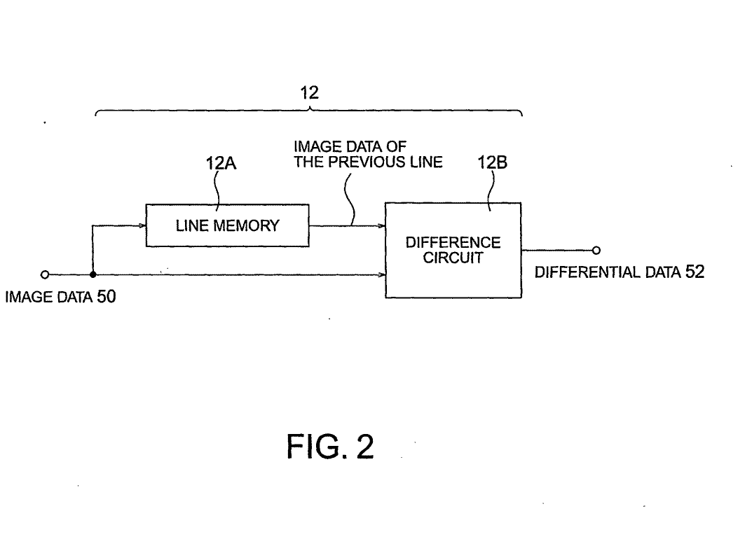

FIG. 2 is a block diagram showing an example of a configuration of the vertical differential encoding unit 12. The input image data 50 is input to a line memory 12A and a difference circuit 12B. The line memory 12A temporarily retains the input image data 50, delays it for a predetermined time period, and then outputs the retained image data 50 (hereafter referred to as “preceding image data”) to the difference circuit 12B. In the present embodiment, the image data is delayed for one horizontal scanning period by the line memory 12A and then output. The difference circuit 12B performs an exclusive-ORing operation on the image data and the preceding image data and outputs the difference data 52.

If the image data 50 is represented by n bits, then the differential data 52 becomes data of (n+1) bits because 1 bit is needed as a sign bit. In the specific example shown in FIG. 1, the vertical differential encoding unit 12 is provided separately from the graphic controller 10. However, the processing conducted in the vertical differential encoding unit 12 is simple, and it is also easy to incorporate the vertical differential encoding unit 12 into the graphic controller 10.

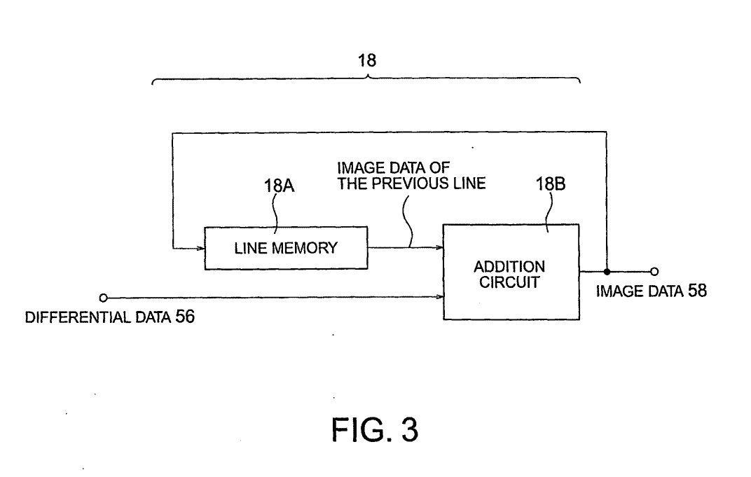

FIG. 3 is a block diagram showing an example of a configuration of the vertical differential decoding unit 18. The input differential data 56 and the preceding image data retained in a line memory 18A are input to an addition circuit 18B. The addition circuit 18B performs an exclusive-ORing operation on the differential data and preceding image data and outputs the image data 58. The output image data 58 is input to the line memory 18A and retained therein for one horizontal scanning period and then input to the addition circuit 18B as the preceding image data. In the concrete example shown in FIG. 1, the signal line drive circuit 20 in the liquid crystal display device is provided separately from the vertical differential decoding unit 18. Since the processing conducted in the vertical differential decoding unit 18 is simple, however, it is also easy to incorporate the vertical differential decoding unit 18 into the signal line drive circuit 20.

On the other hand, the differential signal transmitter 14 converts the parallel digital signal image data 52 to the serial small-amplitude differential signal data 54. In general, the LVDS, TMDS, GVIF (Gigabit Video Interface) or the like is used. In the same way, the differential signal receiver 16 receives the transmitted serial small-amplitude differential signal data 54 and output the parallel digital signal data 56.

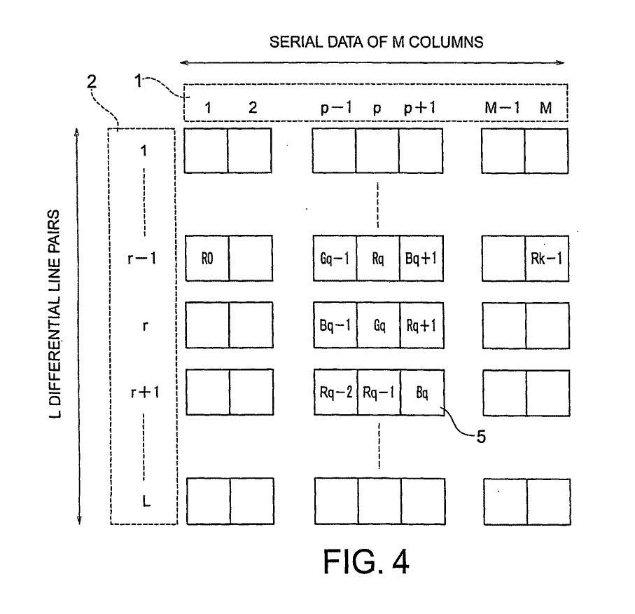

FIG. 4 is a concept diagram for explaining transmission of a serial signal from the differential signal transmitter 14 to the differential signal receiver 16. The serial signal transmission line includes L pairs of differential transmission lines and one pair of clock transmission lines. In other words, the serial differential signal data 54 is transmitted via one pair of clock transmission lines and L pairs of differential transmission lines.

The serial transmission array group 54 represents a signal for transmitting k-bit gray scale level bit data obtained by converting image gray scale level data to binary number data, as M-column serial data over the L pairs of differential transmission lines within one clock period. For example, image gray scale level data Gq in an arbitrary pth column among serial data in 1st to Mth columns and over an arbitrary rth line pair among 1st to Lth differential transmission line pairs is arranged. Here, R, G and B respectively stand for red, green and blue, and q stands for an arbitrary qth bit among the k-bit gray scale bit data.

FIG. 4 will be described in detail.

A data array element in the pth column and the rth line pair is Gq. This indicates that a green q-bit data value is arranged. The green may be R (red) or B (blue). What is desired to be indicated in FIG. 4 is that the left side is always lower or equivalent in bit order than array elements located on the right side in the same differential wire pair (the rth line pair in the horizontal direction in FIG. 4). The transition probabilities of 0→1 and 1→0 in data bit value can be made small by arranging the vertical differential data bit values in a bit order ascending direction or a bit order descending direction. As for the colors in the horizontal direction, the same colors are desirable because correlation between bit values becomes strong and consequently the above-described transition probability becomes smaller. Even if the colors are not the same, however, the transition probability can be made small. What is desired to be indicated in FIG. 4 is that the number of bits in bit array elements in an adjacent differential wire pair is ±1 or equivalent in the same column (the p-th column in the vertical direction in FIG. 4). As for the vertical difference data bit value, the difference in data bit value according to the color is smaller as compared with the original picture. In other words, since the red, blue and green are also easy to take the same value at the same data bit, waveforms of adjacent differential wire pairs can be made the same by aligning the number of bits of adjacent differential wire pairs. And finally, waveforms of adjacent differential wires can be made opposite in phase by inverting bit values between adjacent differential wire pairs.

First, an EMI reducing effect owing to the adjacent data bit reversal on different wires will be described. In the differential transmission, the influence of the power supply face and the ground face is small. In some cases, however, common mode transmission is included without intention by unbalance between waveform rising and falling and an impedance discontinuous part. The fact that a great radiant intensity is caused when a common mode current flows into the power supply face and the ground face will be described.

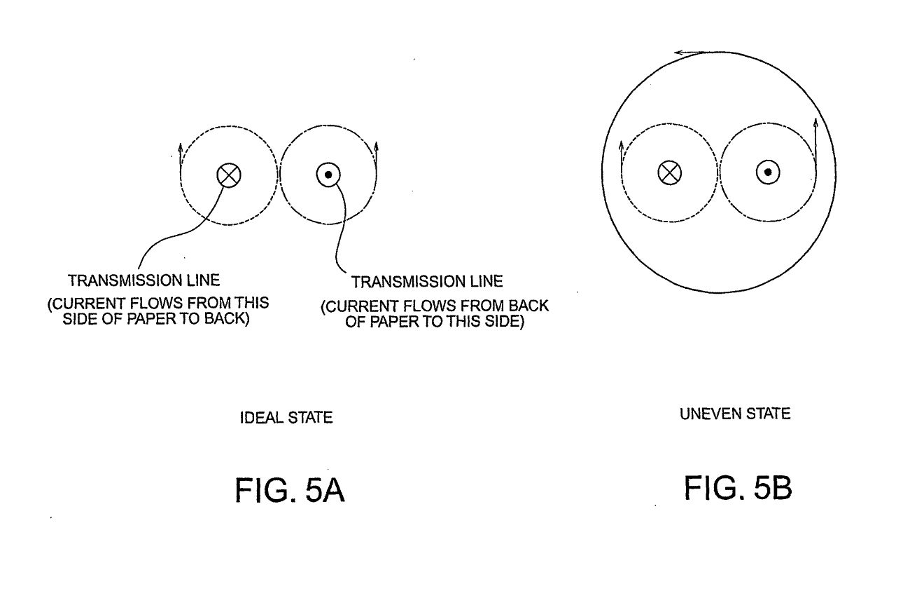

FIGS. 5A and 5B are schematic diagrams showing states of an electromagnetic field generated on a differential signal line when unevenness has occurred in a differential signal. FIGS. 5A and 5B show electromagnetic fields radiated from the differential transmission line when the differential signal potential has changed. An electromagnetic field radiated from a transmission line through which a current flows from this side of paper to the back is represented by a dotted line. An electromagnetic field radiated from a transmission line through which a current flows from the back of the paper to this side is represented by a dot-dash line. Magnitudes of the electromagnetic fields are represented by arrow lengths.

In an ideal differential signal, magnitudes of currents flowing through two differential transmission lines are equal to each other as shown in FIG. 5A. Therefore, electromagnetic fields radiated from two differential transmission lines are equal in magnitude and opposite in phase. As a result, the electromagnetic field comes in a closed state, and radiation to the outside becomes very small.

If rise transition time of a differential signal is different from fall transition time, however, magnitudes of currents flowing through two differential transmission lines are different as shown in FIG. 5B. Accordingly, electromagnetic fields generated from respective transmission lines cannot cancel each other. As a result, an electromagnetic field as represented by a solid line in FIG. 5B is generated from the two differential transmission lines.

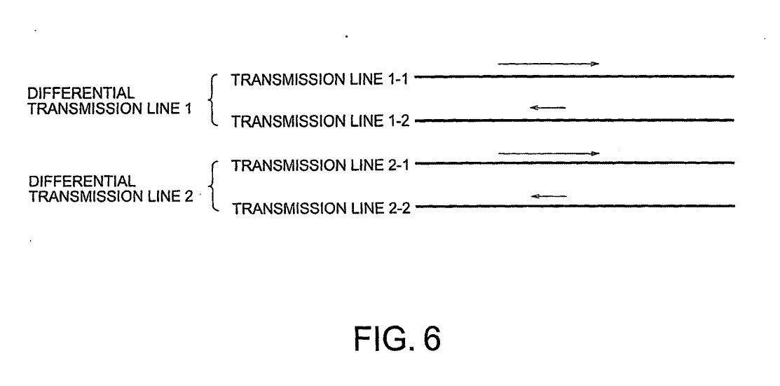

FIG. 6 is a schematic diagram showing current flows generated when potentials on respective differential transmission lines have changed in two sets of differential transmission lines. In two sets of differential transmission lines 1 and 2, “H(1)” and “L(0)” on a transmission line 1-1 and a transmission line 2-2 indicate H and L of a demodulated signal. On a transmission line 1-2 and a transmission line 2-1, differential signals with respect to the transmission line 1-1 and the transmission line 2-2 are transmitted. When signals on both the differential transmission line 1 and the differential transmission line 2 change from L to H, magnitude of currents flowing on the transmission lines 1-1 and 1-2 differ from each other and magnitude of currents flowing on the transmission lines 2-1 and 2-2 differ from each other as shown in FIG. 6 because of “unevenness” in the differential signal. In other words, since transition time in signal from L to H is short, the quantity of the flowing current is small, and since transition time in signal from H to L is long, the quantity of the flowing current is great.

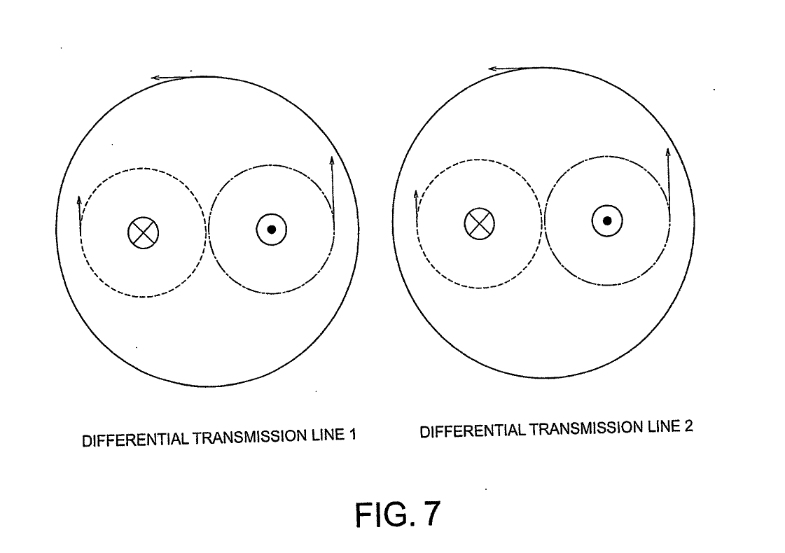

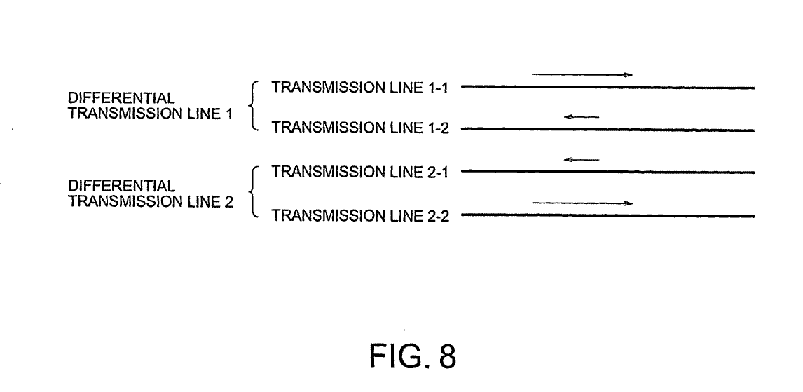

FIG. 7 is a schematic diagram showing electromagnetic fields generated from two differential transmission lines. Since directions of electromagnetic fields generated from respective differential transmission lines are the same, the electromagnetic fields intensify each other and EMI is radiated to the outside.

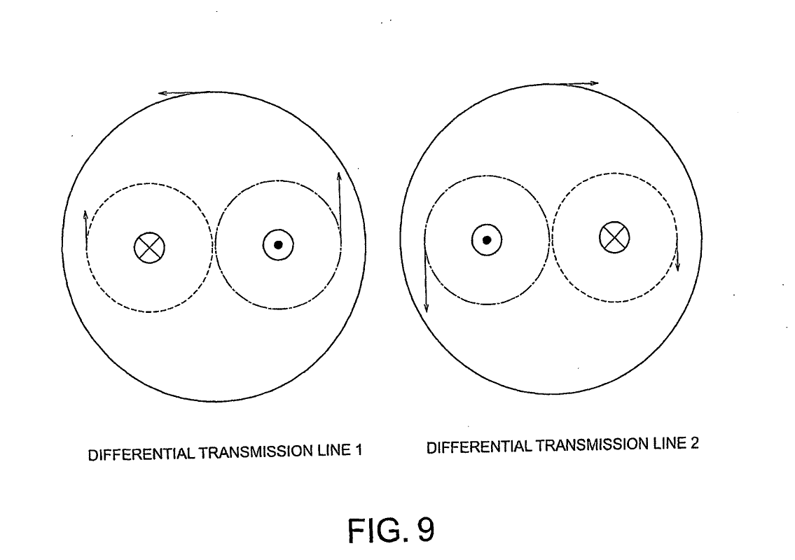

On the other hand, when the signal on the differential transmission line 1 changes from L to H and the signal on the differential transmission line 2 changes from L to H, quantities of currents flowing through the transmission line 1-1 and the transmission line 2-2 become greater than quantities of currents flowing through the transmission line 1-2 and the transmission line 2-1. As for electromagnetic fields generated from two differential transmission lines, directions of electromagnetic fields generated from respective differential transmission lines become opposite in phase as shown in FIG. 9. As a result, the electromagnetic fields cancel each other, and consequently EMI becomes small.

When transmitting vertical difference absolute value data on the basis of the present embodiment, the probability that vertical difference absolute value data transmitted over adjacent differential transmission lines will change from L to H or from H to L simultaneously becomes smaller as compared with the case where the image data is transmitted as it is, as described above. Therefore, the probability of occurrence of the state in which electromagnetic fields generated from adjacent differential transmission lines intensify each other falls, and EMI radiated to the outside can be reduced.

Problems of the vertical differential signal and solution methods will now be described.

In the case of the vertical differential signal, a sign bit red (R), green (G) or blue (B) is added. If it is attempted to transmit data by using the same number of data lines as that of the ordinary image signal, therefore, k-bit data must be reduced to (k−1) bits and the color reproducibility is slightly degraded. Accordingly, there are two kinds of countermeasures.

Three signal lines for sign data bit are added by design change of a timing controller and a liquid crystal driver, and transmission is conducted with the number of vertical differential data lines or the number of gray scale levels kept at k bits. Alternatively, in output signals from a transmission IC unit (a transmission IC for LVDS and a timing controller), only Vsync or only Vsync and Hsync among control signals Vsync, Hsync and EnabLe are transmitted and Hsync or Hsync and EnabLe are generated by a reception IC (Reception IC for LVDS and a liquid crystal driver) on the basis of a data signal and a clock signal. In this method, the number of data lines does not increase and gray scale degradation does not occur, either.

A procedure for decreasing the EMI in the present embodiment includes the following three items.

(1) Frequencies of the data waveforms are lowered.

(2) Data waveforms are made to become substantially the same waveform.

(3) Adjacent data waveforms are inverted.

For reducing the EMI regardless of the number of bits and the image kind by the vertical difference processing, it is necessary to extract features of a vertical difference image.

### (Image Kind)

Histograms according to gray scale level with respect to images of two kinds which are typical in images before vertical difference processing are shown. One of the images is a character image, and the other is a natural image. In the present embodiment, the natural image is not restricted to an actually taken image, but includes an image concerning various pictures such as a CG image and an animation image.

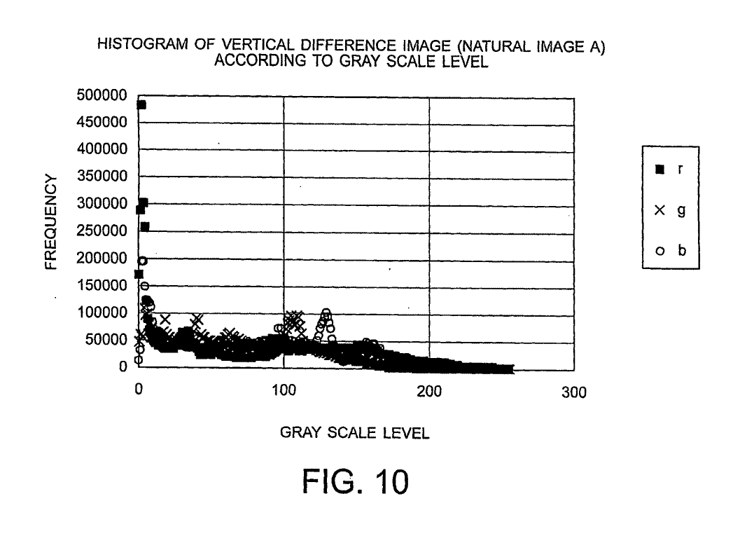

FIG. 10 is a histogram of a natural image according to the gray scale level. The gray scale level assumes a value in a wide width. Frequencies of gray scale levels of R, G and B are also different.

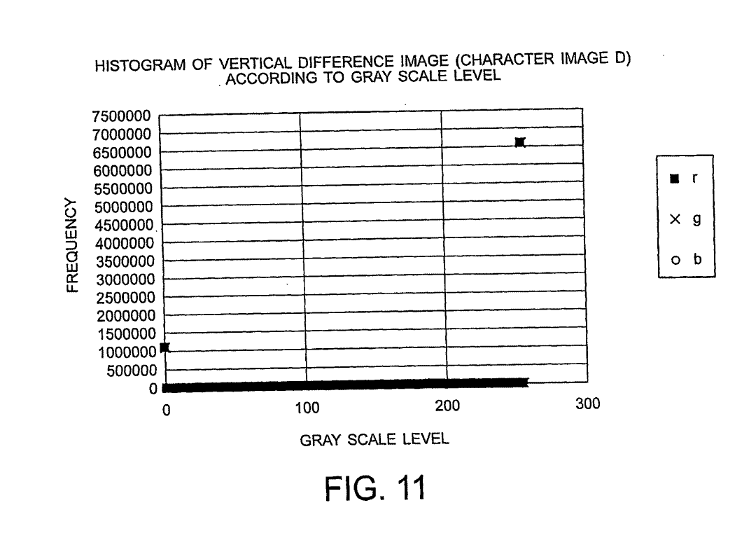

FIG. 11 is a histogram of a character image according to the gray scale level. Gray scale levels are only white (0) and black (255: 8 bits image data). In the same pixel, R, G and B assume substantially the same value.

Image data obtained by conducting vertical difference processing on the natural image shown in FIG. 10 and the character image shown in FIG. 11 will now be described. A digital transmission system which transmits the gray scale level of the image signal as binary data bits will now be described. The vertical difference image has correlation in the vertical direction of the image, i.e., has similar images. Therefore, the difference becomes a value which is substantially equal to 0. The probability of each data bit assuming 0 will be checked every image kind.

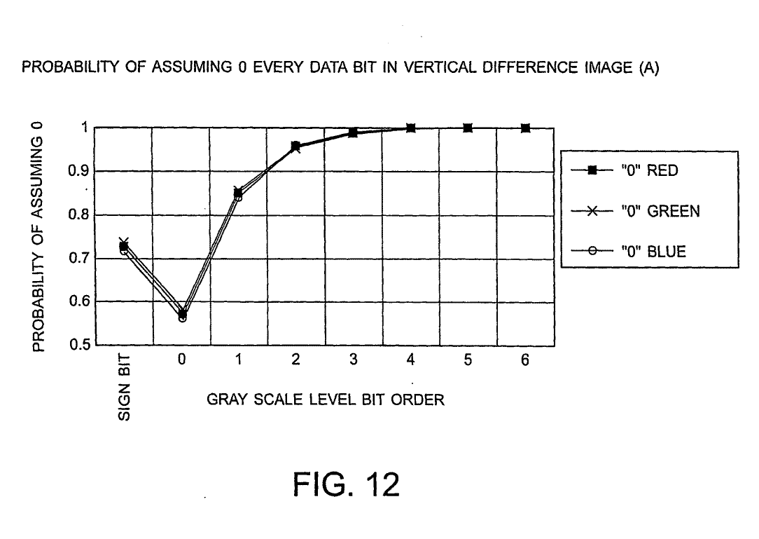

Probabilities of assuming 0 every data bit in the vertical difference images are shown in FIGS. 12 to 16.

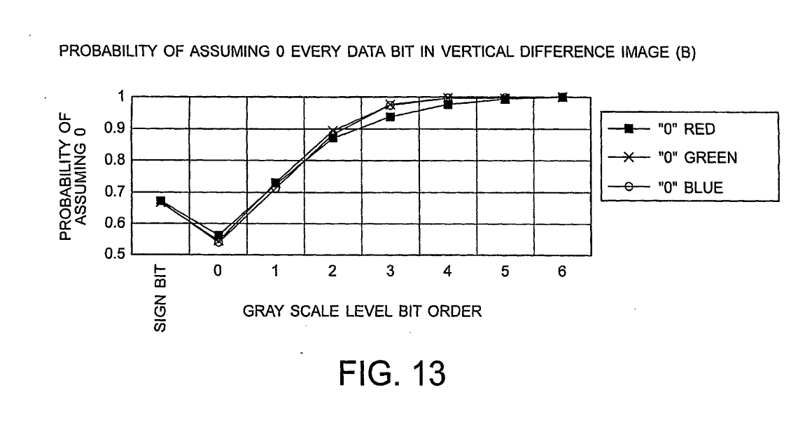

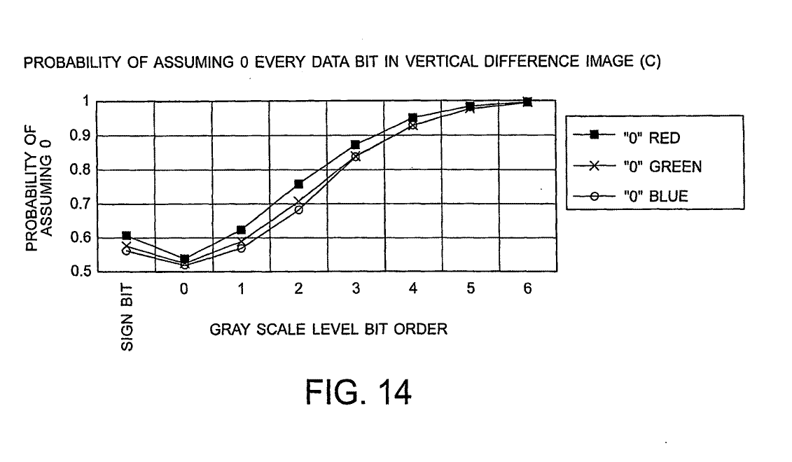

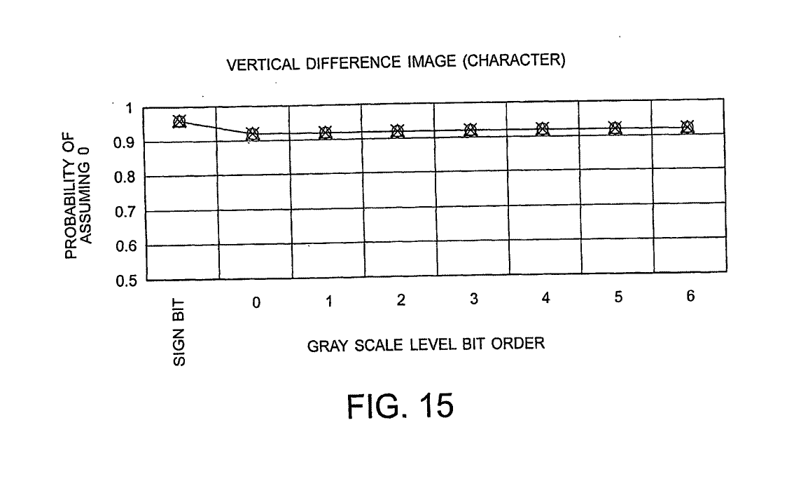

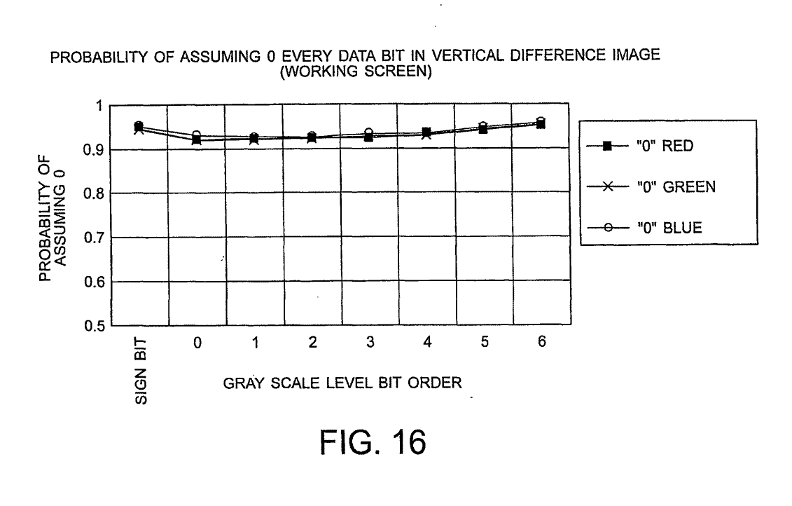

FIG. 12 shows the probability in a natural image A having a low spatial frequency. FIG. 12 shows the probability of assuming 0 every data bit in a vertical difference image obtained by converting the natural image shown in FIG. 10 to the vertical difference image. FIG. 13 shows the case of a natural image B having a spatial frequency which is at a middle level. FIG. 14 shows the case of a natural image C having a high spatial frequency. FIG. 15 shows the case of a character image having a high spatial frequency. FIG. 15 shows the probability of assuming 0 every data bit in a vertical difference image obtained by converting the character image shown in FIG. 11 to the vertical difference image. FIG. 16 shows a working screen for conducting table calculation and composition generation having a high spatial frequency.

Common items regardless of image kind are obtained from the histograms shown in FIGS. 12 to 16.

(A1) In the vertical difference image, the probability of a high order bit assuming 0 is greater than or equal to the probability of a low order bit assuming 0.

(A2) The sign bit is higher in the probability of assuming 0 than the lowest order (0) bit of the vertical difference image. However, the sign bit is lower in the probability of assuming 0 than the second lowest order bit.

(A3) In the same image, the probability of an arbitrary data bit in the vertical difference image assuming 0 has small difference between colors.

The reason for (A1) is that image data has correlation in the vertical direction in both the typical natural image and the character image and consequently the probability of the gray scale level difference assuming 0 or a small number is high.

The reason for (A2) is obtained by considering values which can be assumed by the data value of the sign bit. The sign bit is set equal to 0 when the difference data is positive or 0, whereas the sign bit is equal to 1 when the difference data is negative. In other words, the sign bit does not always become 1 when a difference has occurred. Also, the lowest bit is not always 1, however, the probability of the lowest order bit assuming 0 is the greatest among data bits. Therefore, the probability of the lowest order bit assuming 0 is less than the probability of difference data assuming 0.

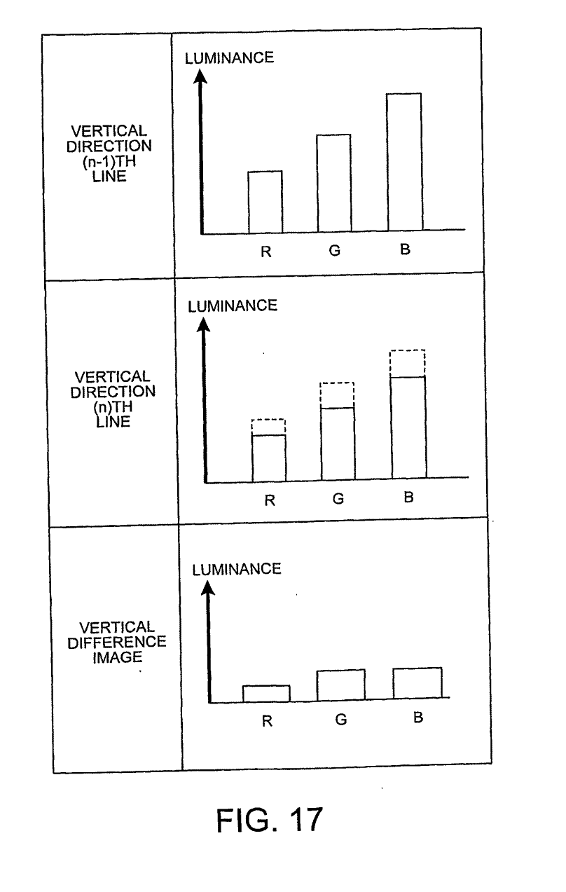

The reason for (A3) will now be described with reference to FIG. 17. FIG. 17 shows luminance of an arbitrary (n−1)th pixel and an arbitrary (n) th pixel in the vertical direction of the same object part in the original picture and a difference image between the two pixels according to R, G and B. In both the natural image and the character image, the correlation in color between adjacent pixels is high as long as the object and the pattern are the same. Especially in the natural image, the luminance becomes gradually dark or bright in a position where light is applied or in a shaded part. Owing to this phenomenon, the frequency of the case where the gray scale level is in an ascending direction, in a descending direction, or is aligned in one of the directions as regards the same object and all colors is high. Conversely speaking, the frequency of a luminance increase in a certain color and a luminance decrease in another color in the same object and the same pattern is low. Therefore, the possibility that the R, G and B values will become the same in luminance of the vertical difference image is high.

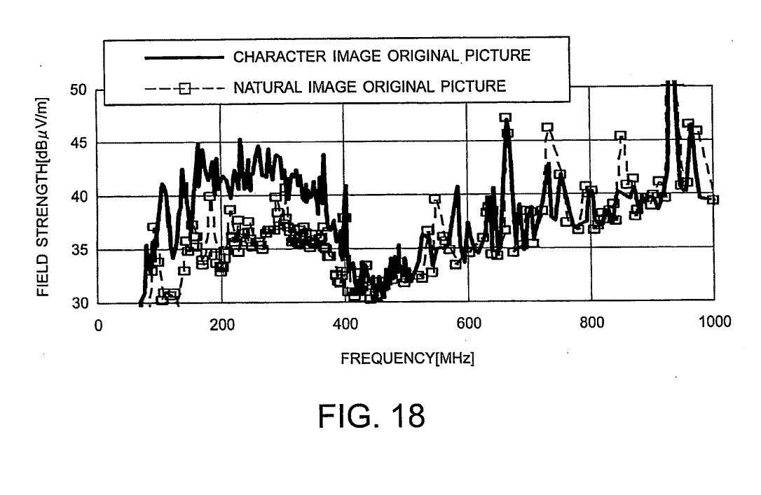

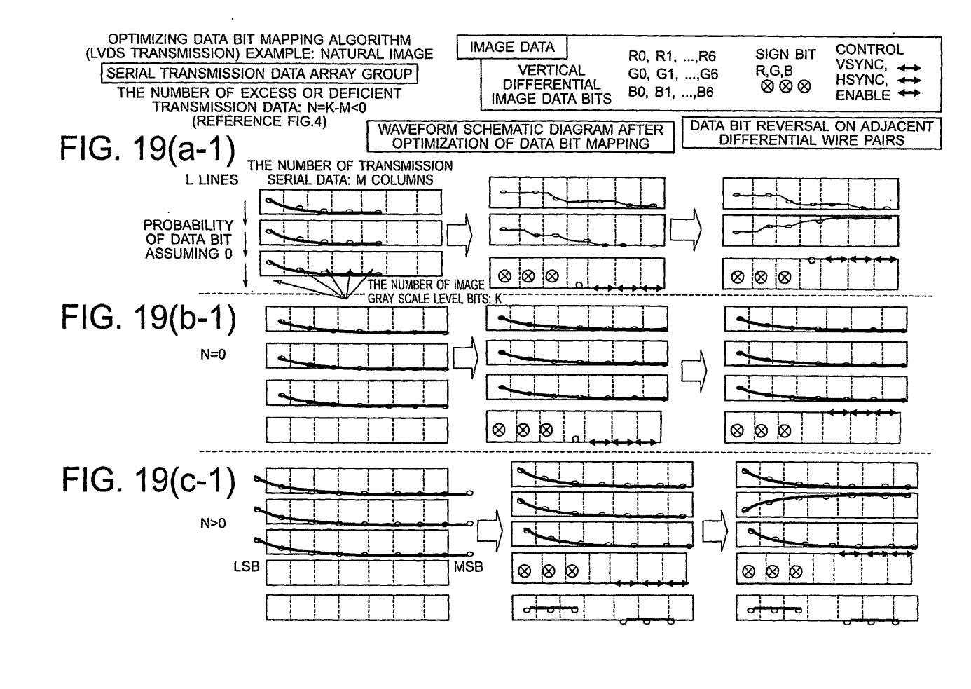

FIG. 18 shows EMI measurement results of a natural image original picture and a character image original picture supplied from a high definition monitor. Radiation is higher in the character image than the natural image. The reason is as follows. In the case of the character image, all data bits of R, G and B make a transition at the same time every pixel and the phase is aligned. If noise is generated in a serial data unit such as an LVDS transmission unit, EMIs intensify each other. That is the reason. In addition, in the case of the character image, the spatial frequency is high and the number of times of data turning on and off increases. As a result, the data frequency is comparatively high.

Hereafter, features of data bits in the character image after the vertical difference processing will be described. In the case of white and black character image, only images of the following three patterns appear.

An arbitrary pixel A ((n)th line←(n−1)th line is white white and black→black)

### (Rfugo, R6, R5, R4, R3, R2, R1, R0)=(0, 0, 0, 0, 0, 0, 0, 0)

### (Gfugo, G6, G5, G4, G3, G2, G1, G0)=(0, 0, 0, 0, 0, 0, 0, 0)

### (Bfugo, B6, B5, B4, B3, B2, B1, B0)=(0, 0, 0, 0, 0, 0, 0, 0)

An arbitrary pixel B ((n)th line (n−1)th line is white→black)

### (Rfugo, R6, R5, R4, R3, R2, R1, R0)=(1, 1, 1, 1, 1, 1, 1, 1)

### (Gfugo, G6, G5, G4, G3, G2, G1, G0)=(1, 1, 1, 1, 1, 1, 1, 1)

### (Bfugo, B6, B5, B4, B3, B2, B1, B)=(1, 1, 1, 1, 1, 1, 1, 1)

An arbitrary pixel C ((n)th line←(n−1)th line is black→white)

### (Rfugo, R6, R5, R4, R3, R2, R1, R0)=(0, 1, 1, 1, 1, 1, 1, 1)

### (Gfugo, G6, G5, G4, G3, G2, G1, G0)=(0, 1, 1, 1, 1, 1, 1, 1)

### (Bfugo, B6, B5, B4, B3, B2, 61, B0)=(0, 1, 1, 1, 1, 1, 1, 1)

First, the fact that the vertical difference image in the case of the character image lowers the data frequency will now be described. FIG. 11 is a histogram of a character image according to the gray scale level. The probability of assuming 0 is low, and it is approximately 15%. FIG. 15 shows the probability of assuming 0 every data bit after conducting the vertical difference processing as a function of gray scale level bit order. The probability of assuming 0 increases to 92%. As a result, the average data frequency becomes low. As for the EMI, unwanted radiated magnetic field noise caused by higher harmonics of the digital data signal poses a problem in many cases. If the data frequency becomes low, therefore, the radiation also decreases because the electromagnetic field radiant intensity caused by a common mode current is proportionate to the frequency.

Features of the sign bit in the character image will now be described. From the foregoing description, all data bits in the vertical difference data assume the same value in pixels A, B and C. On the other hand, as for the sign bit, the vertical difference image data and the sign bit data assume different bit values in an arbitrary pixel C. Furthermore, the probability of both the sign bit and the lowest order bit assuming 0 is closer to 0.5 than other bits. If the sign bit and the lowest order bit are arranged, therefore, transition probabilities of 0→1 and 1→0 increase. For lowering the frequency of serial transmission data, it is desirable to arrange the sign bit on a serial data wire different from the vertical difference image bit.

From the foregoing description, the vertical difference data image assumes nearly the same value regardless of the number of bits in the case of the character image. Even if the bit rearrangement order is changed, therefore, the data frequency does not change. On the other hand, in the natural image, the probability of assuming 0 becomes higher as the data bit becomes higher in order. Even if the data bit order is determined so as to lower the data frequency of data in the natural image, therefore, the EMI reducing effect in the character image does not change.

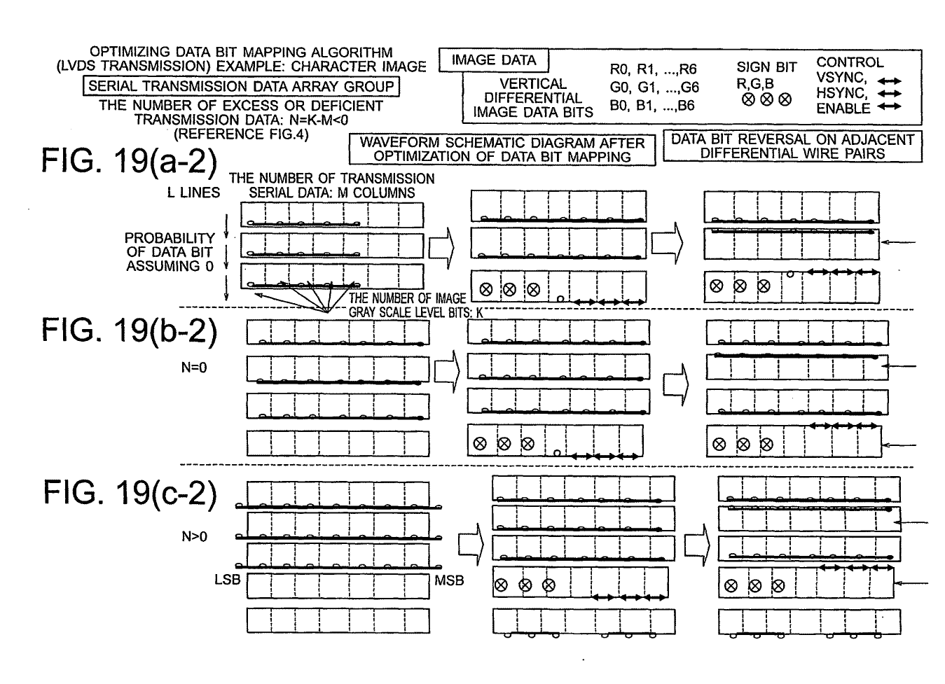

FIGS. 19(a-1) to 19(c-2) (natural image and character image) show a data bit mapping method which is optimum when transmitting a k-bit image signal over a plurality of differential wire pairs storing M-column serial data. The clock signal is transmitted in parallel to the data signal. A high order bit is a value which is high in bit order. For example, in the case of 8-bit gray scale level, the highest order bit is referred to as MSB (the Most Significant Bit) as well, and it is represented as (R7), (G7) and (B7). A low order bit is a value which is low in bit order. For example, in the case of 8-bit gray scale level, the lowest order bit is referred to as LSB (the Least Significant Bit) as well, and it is represented as (R0), (G0) and (B0).

Hereafter, the method of optimum mapping will be described.

When

(B1) the number of serial data in one pixel is M columns,

(B2) the number of gray scale level bits of an image which can be represented on hardware by the display is k,

(B3) sign bit is one bit for each of R, G and B, and

(B4) the number of excess or deficient transmission data is N=K−M,

hereafter the number N of excess or deficient transmission data will be described by classifying into the following three patterns (C1) to (C2):

(C1) N<0

(C2) N=0

(C3) N>0.

First, the case of (C2) which is the simplest case will now be described.

### [(C2): N=0]

The case where 7-bit vertical difference image data and the sign bit are subject to LVDS data transfer as serial data of 4 lines as regards each of R, G and B will now be described. FIGS. 19(b-1) and 19(b-2) show L differential wire pairs which store M-column serial data, and k data bits of a vertical difference image for each of R, G and B. The reason why vertical difference images are coupled by curves is that the probability of each data bit assuming 0 is indicated and the left side indicates low order bits whereas the right side indicates high order bits. In the digital image, the actual data bit assumes a value 0 or a value 1. As the bit value goes downward, therefore, the probability of assuming 1 increases.

Lowering the frequency of the data frequency as described in (1) which is a procedure for reducing the EMI will now be described.

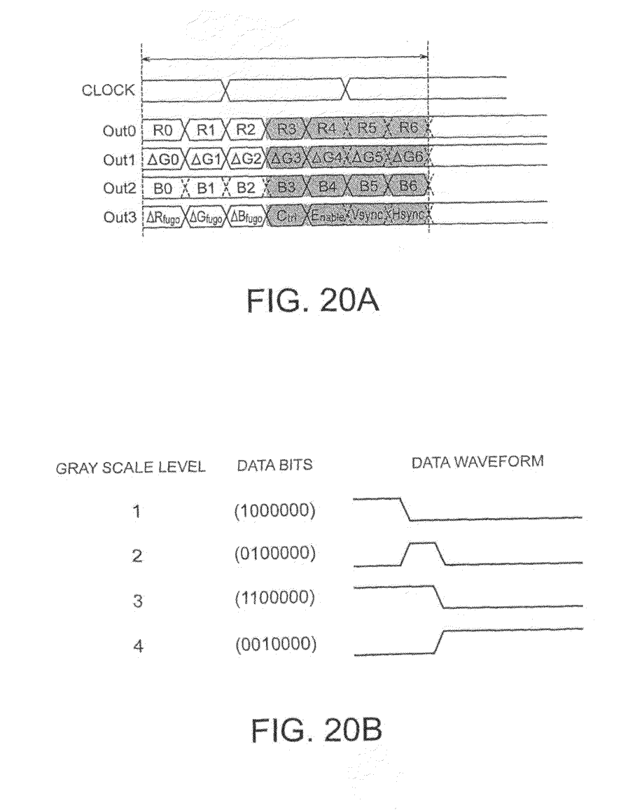

FIGS. 20A and 20B show serial data waveforms obtained when the gray scale level is 1, 2, 3 and 4 in the decimal system. As the gray scale level increases, the number of times of data transition from 0 to 1 or 1 to 0 becomes large when converted to serial data. Furthermore, in the vertical difference image data, the frequency becomes high as the gray scale level becomes low. Therefore, the number of times of data transition from 0 to 1 or 1 to 0 can be suppressed to a small value by arranging bits from low order bits to high order bits. Shaded parts in mapping shown in FIGS. 20A and 20B are data which are few in transition probability, and they are data which assume 1 or 0 stably. Here, delta represents inversion.

For making waveforms on adjacent differential wire pairs the same, it is desirable to make the number of bits on adjacent data wires equal to each other as shown in FIGS. 20A and 20B. For example, in the case of the vertical difference image, the probability that data values in the same bit will assume the same value even if the color is changed is high. As a result, it is desirable to arrange data bit values having the same bit value or a difference of at least one bit in adjacent data array elements.

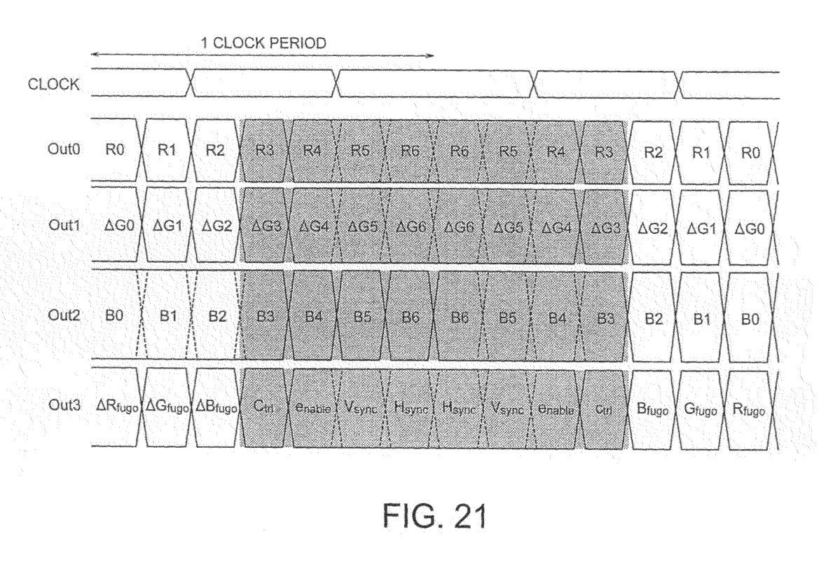

When transmitting serial data of one pixel corresponding to one clock period, the frequency can be lowered by reducing the number of times of transition in one clock period. On the other hand, it is attempted to lower the frequency over two pixels corresponding to two clock periods. In other words, if data corresponding to one pixel are arranged in the order of bit ascending, data corresponding to the next pixel are arranged in the order of bit descending as shown in FIG. 21. In other words, if the order of high order bits and low order bits is reversed every clock period, high order bits having a high probability of assuming 0 continue for approximately one clock period. As a result, it is possible to lower the data frequency to approximately half a clock frequency.

In the case of the character image, it is desirable to arrange the sign bit on a differential wire pair which is different from differential wire pairs of vertical difference bit data as described earlier. As for sign bits Rfugo, Gfugo and Bfugo in that case, the probability of the data bit assuming 0 becomes between the lowest order bit and the second lowest order bit (FIGS. 12 to 16). Therefore, it is desirable to combine the sign bit with a control signal which assumes a nearly constant data bit value or the highest order bit. By placing the sign bit of R, G or B in a former half or a latter half of a serial signal and placing the control signal in the latter half or the former half of the serial signal, the probability that transition from 0 to 1 will take place once is increased as in the differential wire pairs of other vertical difference images and a waveform similar to that of a data sequence of the vertical difference image can be obtained.

Considering the sign bit and the control signal, it is difficult in some cases to make data bits the same or displace them within one bit on differential wire pairs of both sides. In that case, data bits are made the same or made to coincide within one bit only on a differential wire pair of one side.

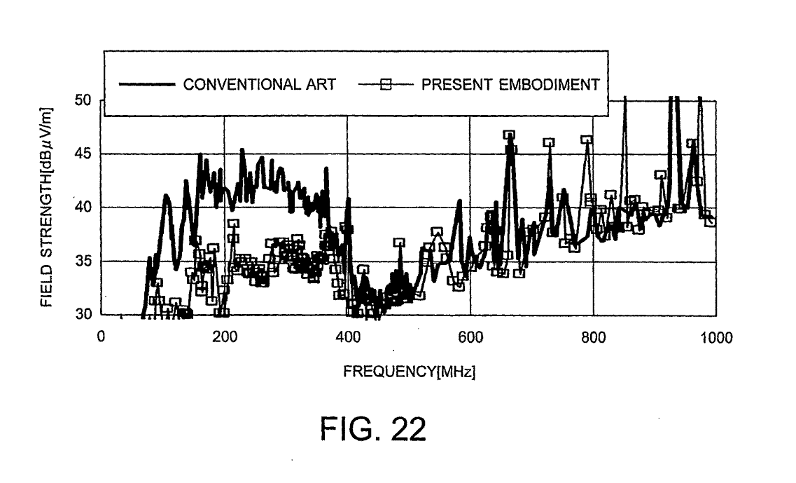

As experiment conditions, an original picture in a character image is used, out2 and out3 are exchanged in the mapping shown in FIG. 21, and the control signal is placed in the same position in the first clock period and the second clock period. FIG. 22 shows a radiant intensity of a vertical component according to the 3M method from a liquid crystal monitor when displaying vertical difference images obtained by inverting data bits on adjacent differential wire pairs. It is appreciated that the radiant intensity in the range of 100 MHz to 300 MHz lowers by approximately 8 dB by using the vertical difference image and conducting the data mapping. It is appreciated that optimization of the vertical difference image and data mapping according to the present embodiment is effective.

In order to cope with a plurality of gray scale level bits, image data bit values obtained after the vertical difference processing are compared as regards 8-bit natural image B and 7-bit natural image B.

(D1) 8-bit natural image original picture→7-bit vertical difference image+sign bit

(D2) 8-bit natural image original picture→7-bit natural image original picture (with the lowest order bit discarded)→6-bit vertical difference image+sign bit

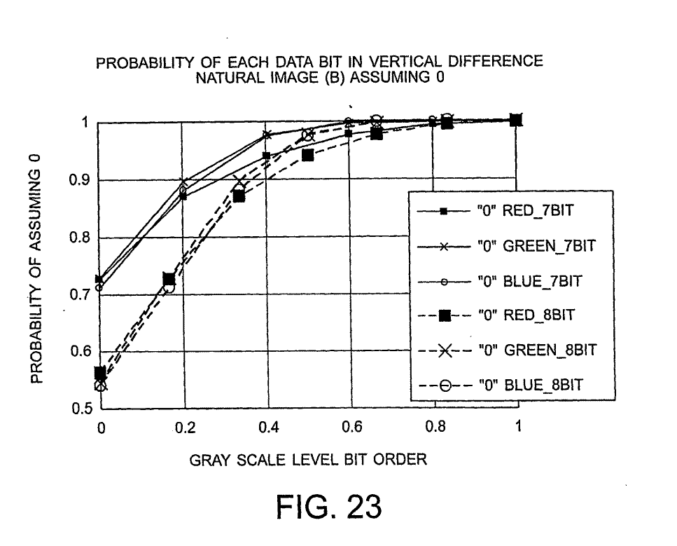

FIG. 23 shows results. The axis of abscissas is normalized so as to set the lowest order bit equal to 0 and set the highest order bit equal to 1. The axis of ordinates indicates the probability of a data bit assuming 0. It is appreciated from FIG. 23 that the probability of every vertical difference image data bit assuming 0 in the case of 7 bits increases as compared with the case of 8 bits. Obtaining a difference in the vertical direction is equivalent to rounding the lowest order bit of the vertical direction image data. Therefore, it is considered that the frequency of the value becoming 0 increases as compared with that obtained the number of bits in the original picture is decreased. It can be said that the probability of assuming 0 increases in every data bit in the image of the 7-bit original picture as compared with the image of the 8-bit original picture. It is appreciated from FIG. 23 that the features (A1) to (A3) of the vertical difference image are satisfied even if the gray scale level is lowered. When N<0 and N>0 as well, therefore, optimization of data bit mapping is conducted on the basis of the features (A1) to (A3).

### [(C1): N<0]

It is supposed that the number of serial data array elements is M columns and k image data bits in the vertical difference image are less than M columns. Optimum data bit mapping in this case will now be described with reference to FIGS. 19(a-1) and 19(a-2). As an example, a procedure required when transferring 5-bit vertical difference image data and the sign bit of R, G and B by using 3-lines by 7-column serial data will now be described.

The sign bit is arranged in the former half or latter half of serial data of one line regardless of the order of R, G and B.

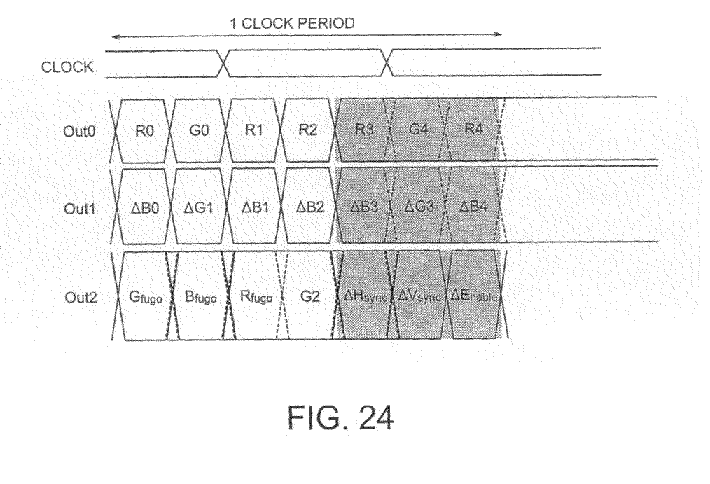

The control signals Vsync, Hsync and enable are placed in the latter half or the former half of the same serial data. At this time, the control signals are 1 in the greater part of one frame period, and they become 0 only when transmitting a signal. Therefore, Vsync, Hsync and enable are inverted so as to obtain the same waveforms as those of high order bits on adjacent differential wire pairs (FIG. 24).

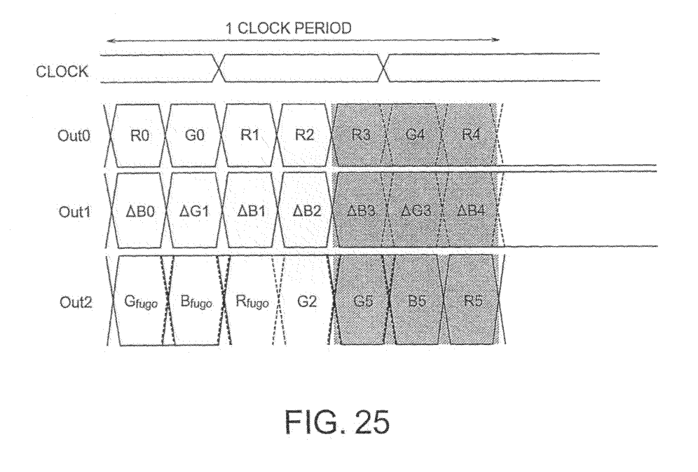

The case where the sign bit is made intact and the control signals are removed so as not to cause the gray scale level degradation will now be described. In that case, data combined with the sign bit is not only with the control signals but also the highest order bit (R, G and B) having the highest probability of assuming 0 (FIG. 25).

In the case of 6 bits, the gray scale level degradation becomes conspicuous if the number of bits is decreased. Therefore, it is more desirable to decrease the control signal lines and increase the sign bits in the image data.

The vertical difference image data of five bits are divided into two lines so as to change from low order bits to high order bits regardless of the color. If a plurality of bits are left over, they are arranged in the center of a serial data part to which the sign bit is assigned. At that time, the same data bit value as the value of the data bit on adjacent differential wire pairs is input.

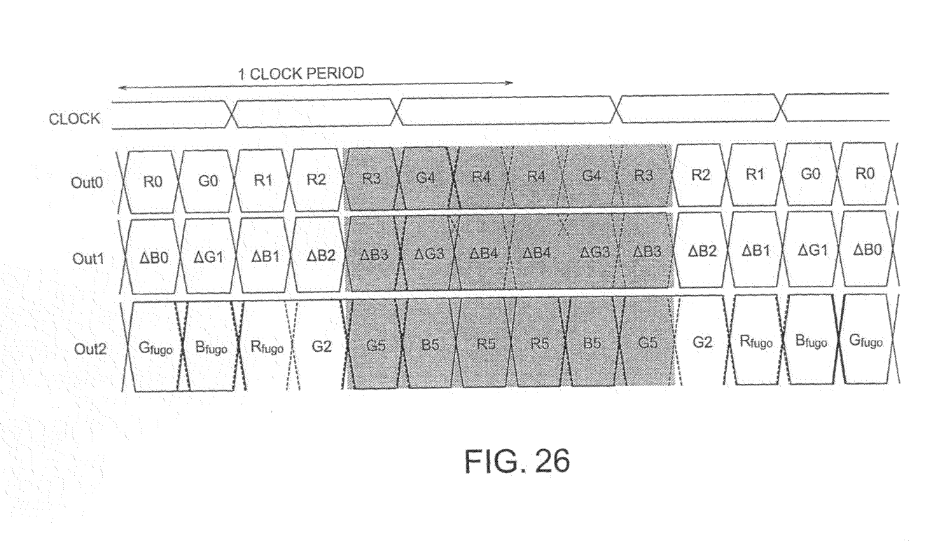

When transmitting serial data of one pixel corresponding to one clock period, the frequency can be lowered by reducing the number of times of transition in one clock period. On the other hand, it is attempted to lower the frequency over two pixels. In other words, if data corresponding to one pixel are arranged in the order of bit ascending, data corresponding to the next pixel are arranged in the order of bit descending as shown in FIG. 26. In other words, if the order of high order bits and low order bits is reversed every clock period, high order bits having a high probability of assuming 0 continue for approximately one clock period. As a result, it is possible to lower the data frequency to approximately half a clock frequency. All data bits on adjacent differential wire pairs are inverted. In the case of signals on three lines, the EMI is further reduced if data bits on the first line and the third line or data bits on the second line are inverted (FIGS. 24 to 26).

### [(C3): N>0]

It is supposed that the number of serial data array elements is M columns and k image data bits in the vertical difference image are greater than M columns. Optimum data bit mapping in this case will now be described with reference to FIGS. 19(c-1) and 19(c-2).

First, as a precondition, the number of array elements transmitted during one clock period must be greater than the number of data signals in order to arrange all data bit sequences into serial data. Therefore, the following expression holds good.

k×3>M×L

If a minimum L satisfying this expression is selected, data bits of the image can be transmitted by using a minimum number of lines.

The following operation slightly differs depending upon whether excess N is an odd number or an even number. In other words, if the excess N is an even number, the excess can be moved the same number in the lower part of k-bit image data and in the higher part of the k-bit image data when moving the excess to a different column. If the excess N is an odd number, however, the excess can be moved only different numbers in the lower part of k-bit image data and in the higher part of the k-bit image data when moving the excess to a different column.

(D1) k−M is an even number

### Out0 R_{(k-M)/2}, R_{(k-M)/2}+1, R_{(k-M)/2}+2, . . . , R_{(k+M)/2}−1

### Out1 G_{(k-M)/2}, G_{(k-M)/2}+1, G_{(k-M)/2}+2, . . . , G_{(k+M)/2}−1

### Out2 B_{(k-M)/2}, B_{(k-M)/2}+1, B_{(k-M)/2}+2, B_{(k+M)/2}−1

### Out3 R0, G0, B0, . . . , Rk-1, Gk-1, Bk-1

. . .

### Out(L-2) R_{(k-M)/2}−1, G_{(k-M)/2}−1, B_{(k-M)/2}−1, R_{(k+M)/2}, G_{(k+M)/2}, B_{(k+M)/2}

### Out(L-1) Rfugo, Gfugo, Bfugo, . . . , Vsync, Hsync, Enable

(D2) k−M is an odd number

### Out0 R_{(k-M-1)/2}, R_{(k-M-1)/2}+1, R_{(k-M-1)/2}+2, R_{(k+M-1)/2}−1

### Out1 G_{(k-M-1)/2}, G_{(k-M-1)/2}+1, G_{(k-M-1)/2}+2, G_{(k+M-1)/2}−1

### Out2 B_{(k-M-1)/2}, B_{(k-M-1)/2}+1, B_{(k-M-1)/2}+2, B_{(k+M-1)/2}−1

### Out3 R0, G0, B0, . . . , Rk-2, Gk-2, Bk-2

. . .

### Out(L-2) R_{(k-M)/2}−1, G_{(k-M)/2}−1, B_{(k-M)/2}−1, . . . , R_{(k+M-1)/2}, G_{(k+M-1)/2}, B_{(k+M-1)/2}

### Out(L-1) Rfugo, Gfugo, Bfugo, Rk-1, Gk-1, Bk-1

When k−M is an odd number, it is desirable to dispose the control signals in a non-array part, i.e., a center column of a data bit array ranging from out3 to out(L-1) of the above-described differential wire pairs without combining the control signals with the sign data bit, or transmit the control signals on a different differential wire pair.

As an example, a procedure required when transferring 9-bit vertical difference image data and the sign bit of R, G and B by using 5-lines by 7-column serial data will now be described.

In the serialized data sequence, data mapping can be conducted only to the seventh column. Which data bit should be moved to another data column will now be described.

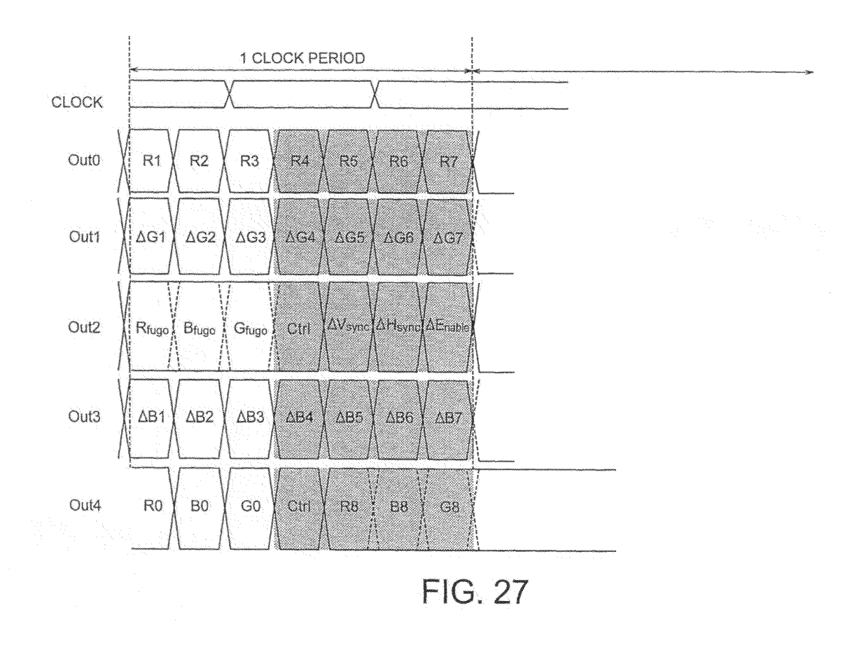

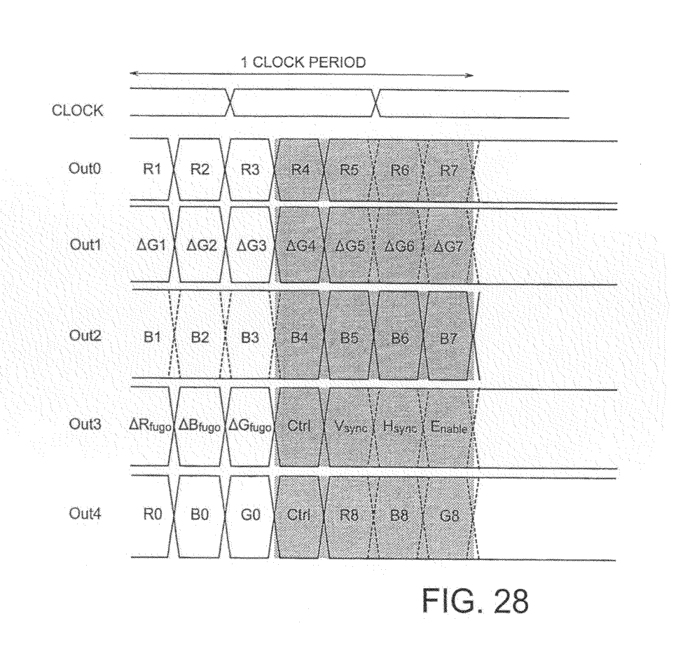

The sign bit is arranged in the former half or latter half of serial data of one line regardless of the order of R, G and B. The control signals Vsync, Hsync and enable are placed in the latter half or the former half of serial data on the same differential wire pair as the sign bit (FIGS. 27 and 28). If there are a plurality of differential wire pairs, combinations as to which data bit mapping should be placed on adjacent differential wire pairs increase. If data bit mapping is placed so as to cause adjacent data bits to become equal to each other or have a difference of ±1, however, optimum mapping is determined.

As regards the control signals, however, the mapping position is already determined in some cases. Under that condition, therefore, optimum mapping is conducted. For example, FIG. 27 shows desirable mapping. As shown in FIG. 28, however, the positions of the control signals may be provided with flexibility.

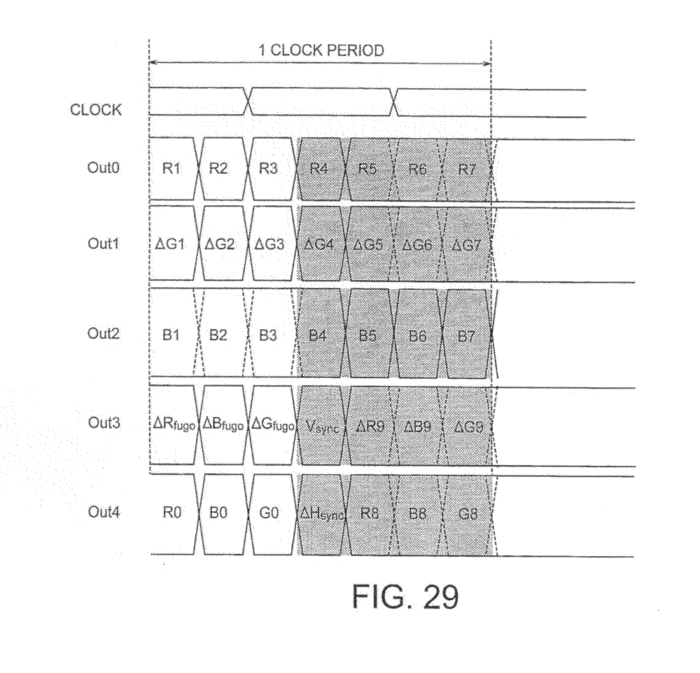

The case where the sign bit is made intact and the control signals are reduced (since enable can be generated from Hsync and the data signal, its priority order is low) so as not to cause the gray scale level degradation will now be described. Data combined with the sign bit is not the control signals, but is the highest order bit (R, G and B) having the highest probability of assuming 0 (FIG. 29).

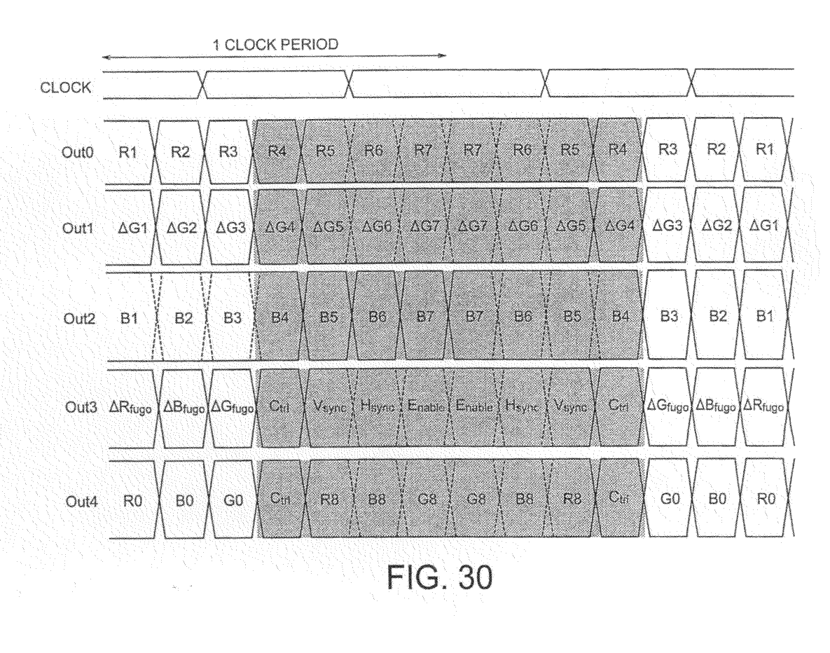

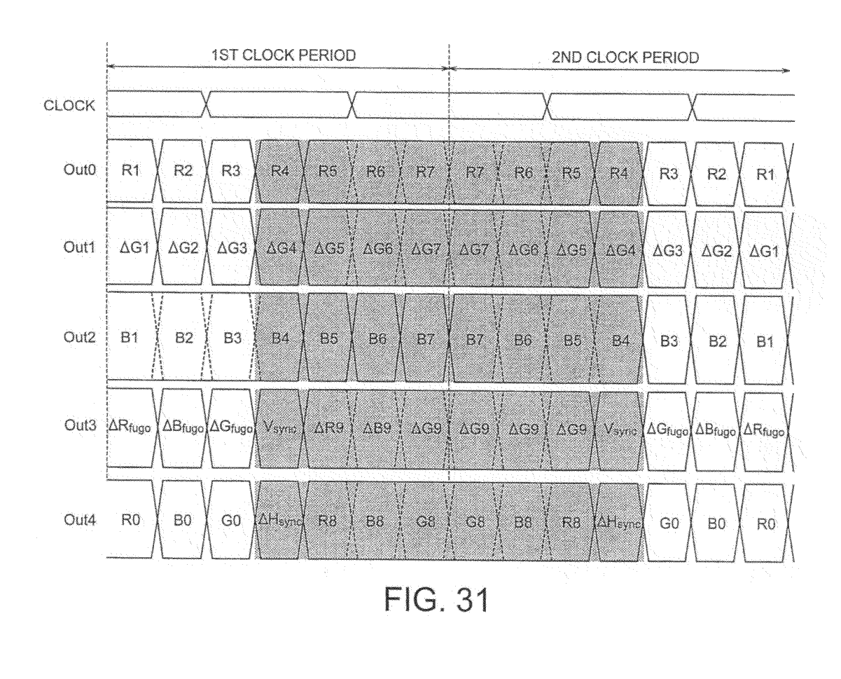

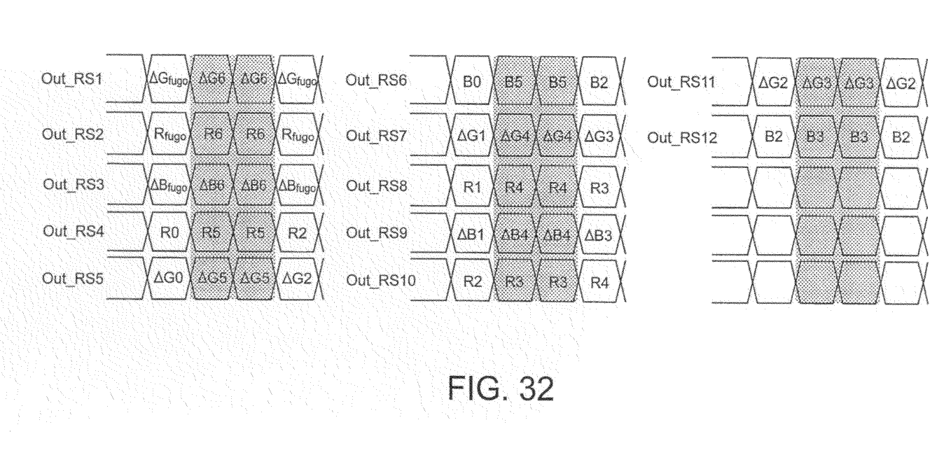

In FIGS. 30 and 31, the frequency is lowered over two pixels corresponding to two clock periods. For making the probability of transition from 0 to 1 or from 1 to 0 small, data are arranged in the order of bit ascending or bit descending. In other words, if data corresponding to one pixel are arranged in the order of bit ascending, data corresponding to the next pixel are arranged in the order of bit descending as shown in FIG. 30. In other words, if the order of high order bits and low order bits is reversed every clock period, high order bits having a high probability of assuming 0 continue for approximately one clock period. As a result, it is possible to lower the data frequency to approximately half a clock frequency.

Which 7 bits should be cut out among 9 bits will now be described. It is appreciated from FIG. 23 that the probability of each bit assuming 0 decreases as the number of bits of the original picture increases as compared with the case where the number of bits of the original picture is small. Therefore, not only the lowest order bit but also data as far as the second lowest order bit falls in probability assuming 0. If the lowest order bit and the second lowest order bit are arranged on different differential wire pairs, therefore, the possibility that the frequency can be lowered is greater as compared with they are arranged serially. Furthermore, when the lowest order bit is moved to a different serial data, it is desirable that a data bit to be combined with them is the stable highest order bit. Considering that all data are provided with the same data waveforms, 7 central bits among 9 bits, i.e., the second to eighth bits (for example, R1 to R7) are cut off, and R, G and B corresponding to three lines are arranged in out0, out1 and out3, or out0, out1 and out2. In data transmission on two remaining lines, the sign bit Rfugo, Gfugo and Bfugo and the control signals Vsync, Hsync and enable are arranged in out2 or out3 serially and the lowest order bit R0, B0 and G0 and the highest order bit R8, B8 and G8 are arranged in out4 serially as shown in FIGS. 28 and 30.

Which 7 bits should be cut out among 10 bits will now be described. It is appreciated from FIG. 23 that the probability of each bit assuming 0 decreases as the number of bits of the original picture increases as compared with the case where the number of bits of the original picture is small. Therefore, not only the lowest order bit but also data as far as the second lowest order bit falls in probability assuming 0. If the lowest order bit and the second lowest order bit are arranged on different differential wire pairs, therefore, the possibility that the frequency can be lowered is greater as compared with they are arranged serially. Furthermore, when the lowest order bit is moved to a different serial data, it is desirable that a data bit to be combined with them is the stable highest order bit. Considering that all data are provided with the same data waveforms, 7 central bits among 10 bits, i.e., the second to eighth bits are cut off, and R, G and B corresponding to three lines are arranged in out0, out1 and out2. In data transmission on two remaining lines, the sign bit Rfugo, Gfugo and Bfugo and the highest order bit R9, B9 and G9 are arranged in out3 serially, and the lowest order bit R0, B0 and G0 and the second highest bit R8, B8 and G8 are arranged in out4 serially as shown in FIGS. 29 and 31.

In addition, common mode noise can be reduced by making waveforms on five adjacent differential wire pairs nearly equal and then inverting mutual data bit values.

### Second Embodiment

As a transmission system using differential wire pairs in a liquid crystal module substrate, there is the RSDS transmission system. In the RSDS transmission system, the data frequency is read at a rising edge and a falling edge of one clock pulse and consequently two data can be transmitted in one clock period. As for the differential wire pairs for data as well, transmission is conducted by using as many lines as half of the number of data bits×3 (R, G and B). This corresponds to the case where N=K−M=k−2>0.

FIG. 32 shows mapping for transmitting the 7-bit vertical differential signal and the sign bit of three lines.

The sign bit has been combined with the control signals heretofore. Since the control signals are transmitted independently in the substrate in many cases, the sign bit is combined with the highest order bit. In this combination, the highest bit has high probability of assuming 0 and the sign bit has low probability of assuming 0.

As shown in FIG. 32, nearly the same data bits are combined on adjacent differential wire pairs in many cases. Waveforms on adjacent differential wire pairs can be made nearly the same when the sign bit of R, G and B and the highest order bit or the lowest order bit of R, G and B and the second highest order bit are arranged on differential wire pairs as compared when R's, B's and G's are adjacent on differential wire pairs as in the conventional art.

When providing adjacent differential wire pairs with opposite phases, there are already inverted data bits in LVDS transmission data transmitted from the personal computer side. Therefore, circuits added to the IC can be prevented from increasing by conducting transmission so as not to recover from the inversion. For example, if RSDS transmission is conducted with the data bits in FIG. 20 intact, G0 to G7 are already inverted. Therefore, data bit mapping can be implemented as shown in FIG. 32 by conducting only data inversion on Bfugo, B6, B1 and B4.

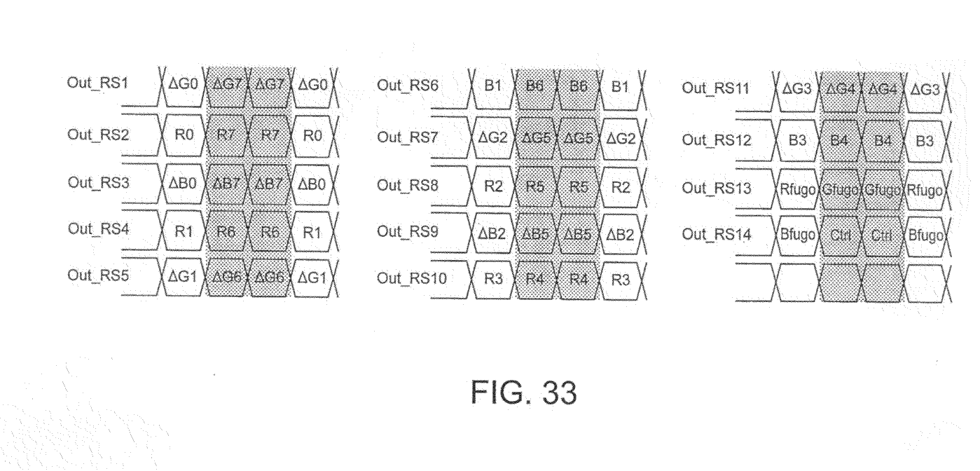

FIG. 33 shows mapping for transmitting the 8-bit vertical differential signal and the sign bit of three lines.

The sign bit has been combined with the control signals or the highest order bit heretofore. Since the vertical differential signal has 8 bits, i.e., even lines, excess or deficiency is eliminated by combining vertical difference data each other. As for the sign bit, therefore, sign bits are combined with each other. At this time, the probability of the sign bit assuming 0 becomes nearly 60% in some cases. If transmission is conducted intact without inversion, therefore, the data frequency becomes low.

When providing adjacent differential wire pairs with opposite phases, there are already inverted data bits in LVDS transmission data transmitted from the personal computer side. Therefore, circuits added to the IC can be prevented from increasing by conducting transmission so as not to recover from the inversion. For example, if RSDS transmission is conducted with the data bits in FIG. 20 intact, G0 to G7 are already inverted. Therefore, data bit mapping can be implemented as shown in FIG. 33 by conducting only data inversion on B0, B7, B2 and B5.

As adjacent differential wire pairs, R, G and B are arranged alternately as shown in FIG. 33 because the probability of assuming 0 is high if the data bits are the same.

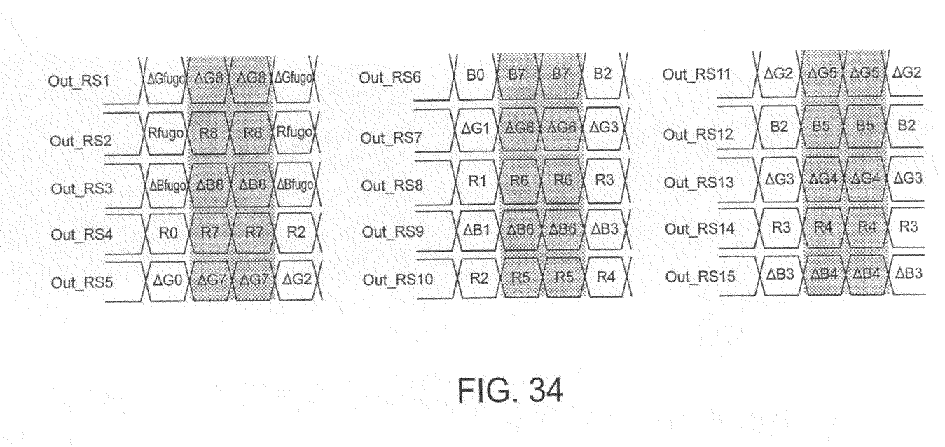

FIG. 34 shows mapping for transmitting the 9-bit vertical differential signal and the sign bit of three lines.

The sign bit has been combined with the control signals heretofore. Since the control signals are transmitted independently in the substrate in many cases, the sign bit is combined with the highest order bit. In this combination, the highest bit has high probability of assuming 0 and the sign bit has low probability of assuming 0.

As shown in FIG. 34, nearly the same data bits are combined on adjacent differential wire pairs in many cases. Waveforms on adjacent differential wire pairs can be made nearly the same when the sign bit of R, G and B and the highest order bit or the lowest order bit of R, G and B and the second highest order bit are arranged on differential wire pairs as compared when R's, B's and G's are adjacent on differential wire pairs as in the conventional art.

When providing adjacent differential wire pairs with opposite phases, there are already inverted data bits in LVDS transmission data transmitted from the personal computer side. Therefore, circuits added to the IC can be prevented from increasing by conducting transmission so as not to recover from the inversion. For example, if RSDS transmission is conducted with the data bits in FIG. 20 intact, G0 to G7 are already inverted. Therefore, data bit mapping can be implemented as shown in FIG. 34 by conducting only data inversion on Bfugo, B8, B1, B6, B3 and B4.

In the case of the character image, the sign bit of three kinds (Rfugo, Gfugo and Bfugo) changes in sign simultaneously when transition from white to black or transition from black to white occurs. Furthermore, the sign bit does not coincide with the difference image data bit value in some cases. Therefore, the probability of assuming 1 in the former half or the latter half of a serialized data wire and the probability of assuming 0 in the latter half or the former half of the serialized data wire are raised by combining the sign bit with a low frequency signal such as the control signal instead of arranging the sign bit on the same serial data wire as the vertical difference image data.

According to the embodiments of the present invention, it becomes possible to reduce the EMI generated from the differential transmission line regardless of the number of bits and the number of serial data when transmitting image data as a serial differential signal as heretofore described. As a result, an image display apparatus which is high in pixel density and compact can be implemented while suppressing the EMI.

Heretofore, embodiments of the present invention have been described with reference to concrete examples. However, the present invention is not restricted to the concrete examples described above. For example, as applicable image display apparatuses, various systems can be mentioned besides the liquid crystal display apparatus as described above.

With respect to the pixel disposition relation, the number of pixels, or kinds and the number of color elements as well, the embodiments are not restricted to the above-described concrete examples. In other words, the present invention is not restricted to the concrete examples. Without departing from the spirit of the present invention, various modifications are possible. All of them are incorporated in the scope of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concepts as defined by the appended claims and their equivalents.

1-3. (canceled)

4. A modulation apparatus comprising:
a differential encoding unit configured to encode digital image data to vertical differential digital data; and
a differential signal transmitter unit configured to transmit a serial signal based on the vertical differential digital data,
wherein
a differential data array group, which have at least a plurality of pairs of a differential data to transmit the serial signal, comprises difference absolute value data having a plurality of bits to represent an absolute value obtained by converting gray scale level data of red, green and blue to binary number data, sign data having at least one bit to be based on the vertical differential digital data of red, green and blue, and control data having Vsync signal, Hsync signal, and Enable signal, and
the differential signal transmitter unit, with respect to one pair of the differential data, arranges the plurality of bits corresponding to one pixel to a serial signal in an ascending order or a descending order, and with respect to another adjacent pair of the differential data, arranges the sign data corresponding to one pixel into a former half or a latter half of a time period for arranging the serial signal corresponding to one pixel, and arranges the control data corresponding to one pixel into the latter half or the former half of the time period for arranging to the serial signal corresponding to one pixel.

5. The apparatus according to claim 4, wherein with respect to one of adjacent differential data, the differential signal transmitter inverts all bits of the serial signal and conducts modulation.

6. The apparatus according to claim 4, wherein the serial signal to be transmitted is obtained by arranging the difference absolute value data corresponding to one pixel in a bit descending order or a bit ascending order.

7-9. (canceled)

10. An image display apparatus comprising:
a differential encoding unit configured to encode digital image data to vertical differential digital data;
a differential signal transmitter configured to transmit a serial signal based on the differential digital data;
at least one pair of differential signal transmission lines used to transmit the serial signal;
a differential signal receiver configured to receive the serial signal transmitted via the differential signal transmission line and output vertical differential digital data;
a vertical differential decoding unit configured to decode the vertical differential digital data to digital image data; and
an image display unit configured to be supplied with the digital image data as an input and display an image based on the digital image data,
wherein
a differential data array group, which have at least a plurality of pairs of a differential data to transmit the serial signal, comprises difference absolute value data having a plurality of bits to represent an absolute value obtained by converting gray scale level data of red, green and blue to binary number data, sign data having at least one bit to be based on the vertical differential digital data of red, green and blue, and control data having Vsync signal, Hsync signal, and Enable signal, and
the differential signal receiver, with respect to one pair of the differential data, modulates the gray scale level data corresponding to one pixel to a serial signal in an ascending order or a descending order, and with respect to another pair of the differential data, arranges the sign data corresponding to one pixel into a former half or a latter half of a time period for arranging the serial signal corresponding to one pixel, and arranges the control data corresponding to one pixel into the latter half or the former half of the time period for arranging the serial signal corresponding to one pixel.

11. The apparatus according to claim 10, wherein with respect to one of adjacent differential data, the differential signal receiver inverts all bits of the serial signal and conducts modulation.

12. The apparatus according to claim 10, wherein the serial signal to be received is obtained by arranging the difference absolute value data corresponding to one pixel in a bit descending order or a bit ascending order.
